(19) United States
(12) Patent Application Publication
(10) Pub. No.: US 2023/0359904 A1
(43) Pub. Date: Nov. 9, 2023

(54) TRAINING DEVICE, TRAINING METHOD AND TRAINING PROGRAM

(71) Applicant: NIPPON TELEGRAPH AND TELEPHONE CORPORATION, Tokyo (JP)

(72) Inventors: Shinya YAMAGUCHI, Musashino-shi, Tokyo (JP); Sekitoshi KANAI, Musashino-shi, Tokyo (JP)

(73) Assignee: NIPPON TELEGRAPH AND TELEPHONE CORPORATION, Tokyo (JP)

(21) Appl. No.: 18/021,810

(22) PCT Filed: Sep. 30, 2020
(86) PCT No.: PCT/JP2020/037257

§ 371 Date: Feb. 17, 2023

(51) Int. Cl. G06N 3/094

(52) U.S. Cl. CPC G06N 3/094

(57) ABSTRACT

The conversion unit (132) converts first data into a first frequency component, and converts second data generated by a generator that configures an adversarial learning model into a second frequency component. The calculation unit (133) calculates a loss function that simultaneously optimizes the generator, a first discriminator that configures the adversarial learning model and discriminates between the first data and the second data, and a second discriminator that configures the adversarial learning model and discriminates between the first frequency component and the second frequency component. The update unit (134) updates parameters of the generator, the first discriminator, and the second discriminator so that the loss function calculated by the calculation unit (133) is optimized.

### TECHNICAL FIELD

The present invention relates to a learning device, a learning method, and a learning program.

### BACKGROUND ART

Conventionally, a deep generation model that is a technique based on a deep learning technique and generates a sample close to a real thing by learning a distribution of learned data is known. For example, generative adversarial networks (GANs) are known as a deep learning model (e.g., refer to Non Patent Literature 1).

### CITATION LIST

### Non Patent Literature

Non Patent Literature 1: Goodfellow, Ian, et al. “Generative adversarial nets.” Advances in neural information processing systems. 2014. (NIPS 2014)

### SUMMARY OF INVENTION

### Technical Problem

However, the conventional technique has a problem. that over-learning may occur and the accuracy of the model may not be improved. For example, a high frequency component not included in actual learning data is mixed in a sample generated by a generator of the learned GAN. As a result, a discriminator performs authenticity determination depending on a high frequency component, and over-learning may occur.

### Solution to Problem

In order to solve the above-described problems and achieve objects, a learning device includes: a conversion unit configured to convert first data into a first frequency component and convert second data generated by a generator that configures an adversarial learning model into a second frequency component; a calculation unit configured to calculate a loss function that simultaneously optimizes the generator, a first discriminator that configures the adversarial learning model and discriminates between the first data and the second data, and a second discriminator that configures the adversarial learning model and discriminates between the first frequency component and the second frequency component; and an update unit configured to update parameters of the generator, the first discriminator, and the second discriminator so that the loss function calculated by the calculation unit is optimized.

### Advantageous Effects of Invention

According to the present invention, it is possible to suppress the occurrence of over-learning and improve the accuracy of the model.

### BRIEF DESCRIPTION OF DRAWINGS

FIG. 1 is a diagram for explaining a deep learning model according to a first embodiment.

FIG. 2 is a diagram for explaining an influence of a high frequency component.

FIG. 3 is a diagram illustrating a configuration example of a learning device according to the first embodiment.

FIG. 4 is a flowchart illustrating a flow of processing of a learning device according to the first embodiment.

FIG. 5 is a diagram illustrating a result of an experiment.

FIG. 6 is a diagram illustrating a result of an experiment.

FIG. 7 is a diagram illustrating a result of an experiment.

FIG. 8 is a diagram illustrating an example of a computer that executes a learning program.

### DESCRIPTION OF EMBODIMENTS

Hereinafter, embodiments of a learning device, a learning method, and a learning program according to the present application will be described in detail with reference to the drawings. Note that the present invention is not limited to the embodiments described below.

GAN is a technique of learning data distribution p_data(x) using two deep learning models of a generator G and a discriminator D. G learns to deceive D, and D learns to distinguish G from learning data. A model in which a plurality of such models has an adversarial relationship may be referred to as an adversarial learning model.

An adversarial learning model such as GAD is used in generation of images, texts, voices, and the like.

Reference Literature 1: Karras, Tero, et al. “Analyzing and improving the image quality of stylegan.” Proceedings of the IEEE/CVF Conference on Computer Vision and Pattern Recognition. 2020. (CVPR 2020)

Reference Literature 2: Donahue, Chris, Julian McAuley, and Miller Puckette. “Adversarial audio synthesis.” arXiv preprint arXiv:1802.04208 (2018). (ICLR 2019)

Reference Literature 3: Yu, Lantao, et al. “Seggan: Sequence generative adversarial nets with policy gradient.” Thirty-first AAAI conference on artificial intelligence. 2017. (AAAI 2017)

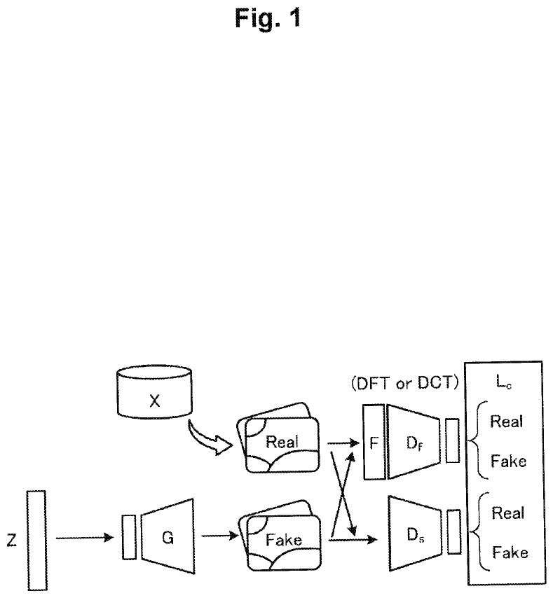

Here, GAN has a problem that D over-learns a learning sample as the learning progresses. As a result, each model cannot perform meaningful update to data generation, and generation quality by the generator deteriorates. This is shown, for example, in FIG. 1 of Reference Literature 4.

Reference Literature 4: Karras, Tero, et al. “Training Generative Adversarial Networks with Limited Data.” arXiv preprint arXiv:2006.06676 (2020).

Moreover, Reference Literature 5 describes that a learned CNN output performs prediction depending on a high frequency component of an input.

Reference Literature 5: Wang, Haohan, et al. “High-frequency Component Helps Explain the Generalization of Convolutional Neural Networks.” Proceedings of the IEEE/CVF Conference on Computer Vision and Pattern Recognition. 2020. (CVPR 2020)

Moreover, Reference Literature 6 describes that a neural network constituting the generator G and the discriminator D of the GAN tends to learn in order from low frequency to high frequency.

Reference Literature 6: Rahaman, Nasim, et al. “On the spectral bias of neural networks.” International Conference on Machine Learning. 2019. (ICML 2019)

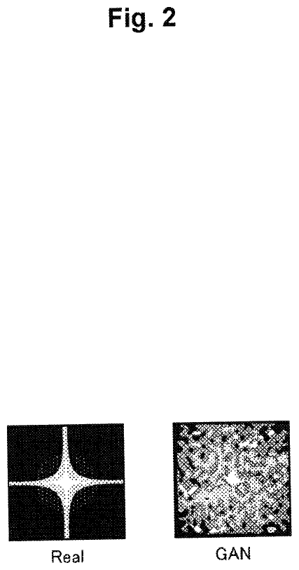

Therefore, an object of the first embodiment is to suppress the occurrence of over-learning and improve the accuracy of the model by reducing the influence of the high frequency component of the data on the generator G and the discriminator D. FIG. 1 is a diagram for explaining a deep learning model according to the first embodiment. Moreover, FIG. 2 is a diagram for explaining an influence of a high frequency component.

As illustrated in FIG. 2, the CIFAR-10 (two-dimensional power spectrum) is different between real data (Real) and data (GAN) generated by the generator. Moreover, Reference Literature 7 shows that data generated by various GANs has an increased power spectrum at a high frequency as compared with real data.

Reference Literature 7: Durall, Ricard, Margret Keuper, and Janis Keuper. “Watch your Up-Convolution: CNN Based Generative Deep Neural Networks are Failing to Reproduce Spectral Distributions.” Proceedings of the IEEE/CVF Conference on Computer Vision and Pattern Recognition. 2020. (CVPR 2020)

Referring back to FIG. 1, in the deep learning model of the present embodiment, a discriminator Dₛ discriminates which data is Real (or Fake) for data (Real) included in a real data set X and data (Fake) generated by the generator G from a random number z. Furthermore, D_{f} discriminates frequency components converted from Real and Fake.

In the conventional GAN, the discriminator D is optimized so that discrimination accuracy of one discriminator is improved, that is, a probability that the discriminator D discriminates Real as Real is increased. Moreover, the generator G is optimized so that the ability of the generator G to deceive the generator G, that is, the probability that the discriminator D discriminates Real as Fake increases.

In the present embodiment, the generator G, the discriminator Dₛ, and the discriminator D_{f} are simultaneously optimized. Hereinafter, details of the learning processing of the deep learning model will be described together with the configuration of a learning device of the present embodiment.

### Configuration of First Embodiment

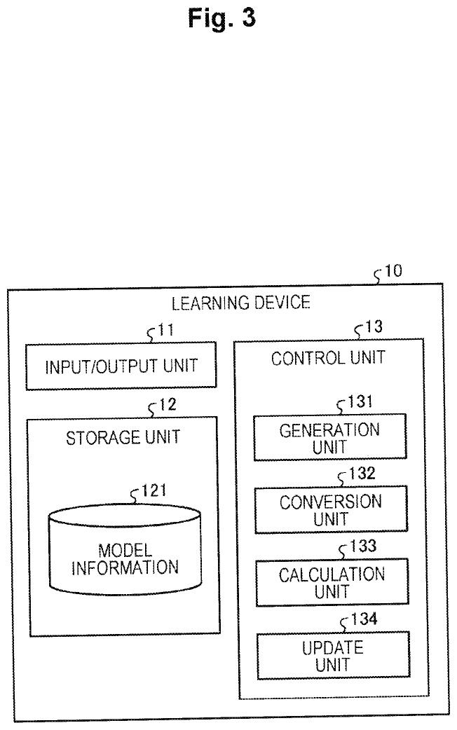

FIG. 3 is a diagram illustrating a configuration example of a learning device according to the first embodiment. A learning device 10 accepts an input of learning data and updates a parameter of a deep learning model. Moreover, the learning device 10 may output an updated parameter. As illustrated in FIG. 3, the learning device 10 has an input/output unit 11, a storage unit 12, and a control unit 13.

The input/output unit 11 is an interface for inputting/outputting data. For example, the input/output unit 11 may be a communication interface such as a network interface card (NIC) for performing data communication with another device via a network. Moreover, the input/output unit 11 may be an interface for connecting an input device such as a mouse or a keyboard, and an output device such as a display.

The storage unit 12 is a storage device such as a hard disk drive (HDD), a solid state drive (SSD), or an optical disk. Note that the storage unit 12 may be a data-rewritable semiconductor memory such as a random access memory (RAM), a flash memory, or a non-volatile static random access memory (NVSRAM). The storage unit 12 stores an operating system (OS) and various programs executed by the learning device 10. Moreover, the storage unit 12 stores model information 121.

The model information 121 is information such as parameters for constructing a deep learning model, and is appropriately updated in the learning processing. Moreover, the updated model information 121 may be output to another device or the like via the input/output unit 11.

The control unit 13 controls the entire learning device 10. The control unit 13 is, for example, an electronic circuit such as a central processing unit (CPU), a micro processing unit (MPU), or a graphics processing unit (CPU), or an integrated circuit such as an application specific integrated circuit (ASIC) or a field programmable gate array (FPGA). Moreover, the control unit 13 has an internal memory for storing programs and control data defining various processing procedures, and executes each processing using the internal memory. Moreover, the control unit 13 functions as various processing units by operation of various programs. For example, the control unit 13 has a generation unit 131, a conversion unit 132, a calculation unit 133, and an update unit 134.

The generation unit 131 inputs a random number z to the generator G to generate second data.

The conversion unit 132 converts the first data and the second data into frequency, components using a differentiable function. This is for enabling update of the parameters by the back error propagation method. For example, the conversion unit 132 converts the first data and the second data into frequency components by discrete Fourier transform (DFT) or discrete cosine transform (DCT).

The calculation unit 133 calculates a loss function that simultaneously optimizes the generator G, the first discriminator that configures the adversarial learning model and discriminates between the first data and the second data, and the second discriminator D_{f} that configures the adversarial learning model and discriminates between the first frequency component and the second frequency component. Here, the calculation unit 133 calculates the loss function expressed in Formula (1).

$$[ Math . 1 ]$$

$${min}_{G} {max}_{{D}_{s} , {D}_{f}} 𝒥 ( G , {D}_{s} , {D}_{f} ) = {x \sim {p}_{data}}_{} log {D}_{s} ( x ) + {z \sim {p}_{z}}_{} log ( 1 - {D}_{s} ( G ( z ) ) ) + {z \sim {p}_{data}}_{} log {D}_{f} ( F ( x ) ) + {z \sim {p}_{data}}_{} log ( 1 - {D}_{f} ( F ( G ( z ) ) ) ) \qquad ( 1 )$$

F(·) is a function that converts data in a spatial region into a frequency component. The x and G(z) are Real data and Fake data, respectively, and are examples of the first data and the second data. Moreover, F(x) corresponds to the first frequency component. Moreover, F(G(z)) corresponds to the second frequency component.

G(·) is a function that outputs data (Fake) generated by the generator G on the basis of an argument. Moreover, Dₛ(·) and D_{f}(·) are functions that output probabilities of discriminating data input as arguments as Real by the discriminators Dₛ and D_{f}, respectively.

The calculation unit 133 further calculates a loss function having a first term that decreases as the discrimination accuracy of the first discriminator Dₛ increases, and a second term that decreases as the discrimination accuracy of the second discriminator D_{f} increases. Here, the calculation unit 133 may calculate a loss function by multiplying the first term by a first coefficient larger than 0 and smaller than 1, and multiplying the second term by a second coefficient obtained by subtracting the first coefficient from 1. Specifically, the calculation unit 133 calculates L_{G} expressed in Formula (2). The α is an example of the first coefficient.

[Math. 2]

[symbol]

_{G}=−(α [symbol] _{z·p}_{_{z}} log D_{S}(G(z))−(1−α) [symbol] _{z˜p}_{_{z}} log D_{f}(F(G(z)))) (2)

Here, data before conversion by the conversion unit 132 is referred to as spatial domain data, and data (frequency component) after conversion is referred to as frequency domain data. The loss function of Formula (1) is to obtain an optimal generator G in both the spatial domain and the frequency domain. On the other hand, the optimization of Formula (1) does not necessarily mean that the generator G is optimal for the spatial domain alone and the frequency domain alone.

Therefore, in the present embodiment, it is possible to introduce a trade-off parameter a for giving priority to the spatial domain into the loss function of the generator G as in Formula (2) in order to stabilize the data distribution learning in the spatial domain and improve the Generation quality. Here, α is a hyperparameter.

Furthermore, the calculation unit 133 further calculates a loss function that decreases as the difference between the discrimination accuracy of the first discriminator Dₛ and the discrimination accuracy of the second discriminator D_{f} decreases. Specifically, the calculation unit 133 calculates a loss function as in Formula (3).

[Math. 3]

[symbol]

_{C}=λ_{C}∥Dₛ(x)−D_{f}(F(x))∥² (3)

L_{c} in Formula (3) can be a consistency loss of the discriminator Dₛ for the spatial domain and the discriminator D_{f} for the frequency domain. Here, the data input to the discriminators in both the spatial domain and the frequency domain are different only in the domain, and are originally the same data and also the same in the data distribution to be learned. Therefore, it is desirable that the outputs of the discriminator Dₛ and the discriminator D_{f} coincide with each other.

Formula (3) is a loss for bringing the outputs of the discriminator Dₛ and the discriminator D_{f} close to each other, and thus, knowledge is shared between the discriminator Dₛ and the discriminator D_{f}.

The update unit 134 updates the parameters of the generator, the first discriminator Dₛ, and the second discriminator D_{f} so that the loss function calculated by the calculation unit 133 is optimized. The update unit 134 updates the parameter of each model so as to optimize the loss function of Formulas (1), (2), and (3).

### Processing of First Embodiment

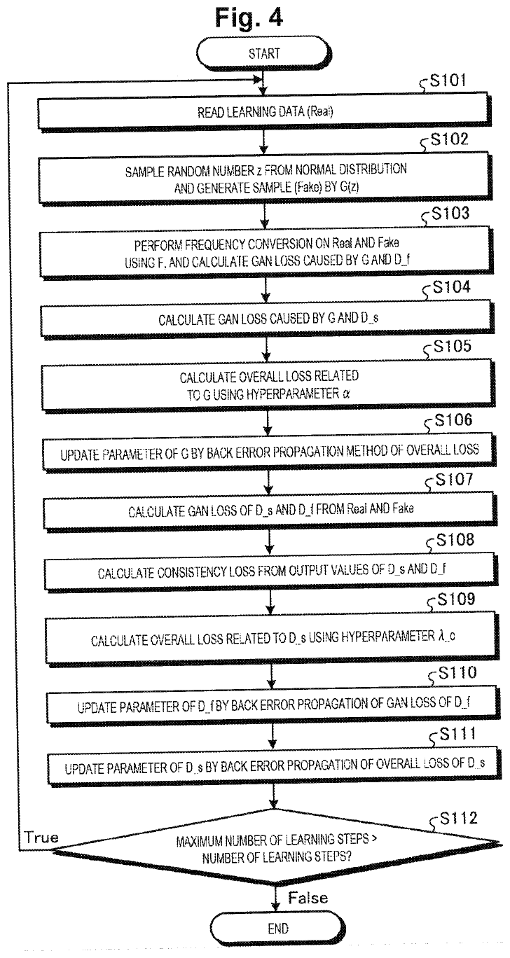

FIG. 4 is a flowchart illustrating a flow of processing of the learning device according to the first embodiment. Hereinafter, D_s and D_f in the drawing have the same meaning as Ds and Df. As illustrated in FIG. 4 the learning device 10 first reads learning data (step S101). Here, the learning device 10 reads real data (Real) as learning data.

Next, the learning device 10 samples a random number z from normal distribution, and generates a sample (Fake) by G(z) (step S102). The learning device 10 performs frequency conversion on Real and Fake using F, and calculates a GAN loss caused by the generator G and the discriminator D_{f} (step S103). The GAN loss caused by the generator G and the discriminator D_{f} corresponds to the fourth term on the right side of Formula (1).

Then, the learning device 10 calculates a GAN loss caused by the generator G and the discriminator Dₛ (step S104). The GAN loss caused by the generator G and the discriminator Dₛ corresponds to the second term on the right side of Formula (1).

Here, the learning device 10 calculates the overall loss related to G using the hyperparameter α (step S105). The overall loss corresponds to L_{G} in Formula (2). The learning device 10 updates the parameter of G by the back error propagation method of the overall loss of Formula (2) (step S106).

Furthermore, the learning device 10 calculates a GAN loss of the discriminator Dₛ and the discriminator D_{f} from Real and Fake (step S107). The GAN loss of the discriminator Dₛ and the discriminator D_{f} corresponds to Formula (1).

Moreover, the learning device 10 calculates the consistency loss from the output values of the discriminator Dₛ and the discriminator D_{f} (step S108). The consistency loss corresponds to the inside of |||| in the right side of Formula (3).

The learning device 10 calculates the overall loss related to Dₛ using the hyperparameter λ_{c} (step S109). The overall loss related to Dₛ using λ_{c} corresponds to L_{c} in Formula (3).

Then, the learning device 10 updates the parameter of D_{f} by back error propagation of the GAN loss of Df (step S110). Moreover, the learning device 10 updates the parameter of Dₛ by back error propagation of the overall loss of Dₛ (step S111).

At this time, in a case where the maximum number of learning steps>the number of learning steps is satisfied (Step S112, True), the learning device 10 returns to step S101 and repeats the processing. On the other hand, in a case where the maximum number of learning steps>the number of learning steps is not satisfied (Step S112, False), the learning device 10 terminates the processing.

### Effects of First Embodiment

As described above, the conversion unit 132 converts the first data into the first frequency component, and converts the second data generated by the generator that configures the adversarial learning model into the second frequency component. The calculation unit 133 calculates a loss function that simultaneously optimizes the generator, the first discriminator that configures the adversarial learning model and discriminates between the first data and the second data, and the second discriminator that configures the adversarial learning model and discriminates between the first frequency component and the second frequency component. The update unit 134 updates the parameters of the generator, the first discriminator, and the second discriminator so that the loss function calculated by the calculation unit 133 is optimized. In this manner, the learning device 10 can reflect the influence of the frequency component in learning. As a result, it is possible with the present embodiment to suppress the occurrence of over-learning and improve the accuracy of the model.

The calculation unit 133 further calculates a loss function having a first term that decreases as the discrimination accuracy of the first discriminator increases, and a second term that decreases as the discrimination accuracy of the second discriminator increases. Moreover, the calculation unit 133 calculates a loss function by multiplying the first term by a first coefficient larger than 0 and smaller than 1, and multiplying the second term by a second coefficient obtained by subtracting the first coefficient from 1. As a result, for example, the generator G can be optimized in the spatial domain alone, not in both the spatial domain and the frequency domain.

The calculation unit 133 further calculates a loss function that decreases as a difference between the discrimination accuracy of the first discriminator and the discrimination accuracy of the second discriminator decreases. As a result, the outputs of the discriminators can be matched in the spatial domain and the frequency domain.

### Experiment

An experiment performed by actually carrying out the above embodiment will be described. The experimental settings are as follows.

Experimental Settings
Data set: CIFAR-100 (Image data set, Class 100)
Learning data set: 50,000 sheets
Neural network architecture: Resnet-SNGAN (Reference Literature 8: Miyato, Takeru, et al. “Spectral normalization for generative adversarial networks.” arXiv preprint arXiv: 1802.05957 (ICLR 2018).)

Experimental Procedure
(1) 100,000 iteration of learning using learning data
(2) Measure generation quality (FID) for each of 1,000 iteration (Reference Literature 9: Heusel, Martin, et al. “Gans trained by a two time-scale update rule converge to a local nash equilibrium.” Advances in neural information processing systems. 2017. (NIPS 2017))
(3) Set model with highest FID score as final learning model
(4) 10 times execution in total for obtaining the mean and the standard deviation of the FID

Experimental Pattern
SNGAN: Baseline (normal GAN) (Reference Literature 8)
CVPR20: Existing technique for minimizing frequency components of generated images (using one-dimensional DFT, Binary Cross-entropy) (Reference Literature 7)
FreqMSE: Frequency component matching loss (using two-dimensional DCT, Mean Squared Error)
SSD2GAN: Simultaneous learning of spatial and frequency domains (two-dimensional DCT)
SSD2GAN+Tradeoff: Introducing trade-off coefficient α (using α=0.8)
SSD2GAN+SSCR: Introducing consistency loss between Dₛ and D_{f} (using λ=0.001)

The technique of adding SSD2GAN and Tradeoff or SSCR corresponds to the first embodiment. Tradeoff is a loss function of Formula (2). Moreover, the SSCR is a loss function of Formula (3). FreqMSE is another technique for improving the accuracy of the model in consideration of the influence of the frequency component by a method different from that of the first embodiment.

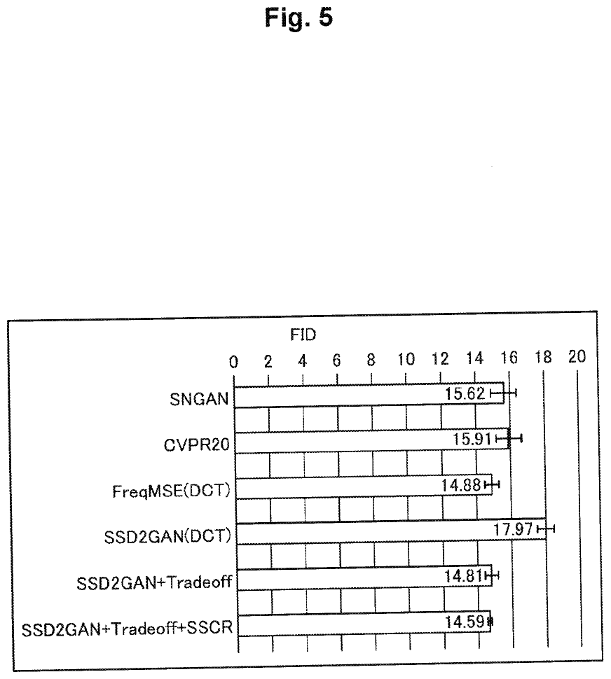

FIGS. 5, 6, and 7 are diagrams illustrating results of an experiment. As illustrated in FIG. 5, FID of the generator G becomes small in FreqMSE and SSD2GAN+Tradeoff+SSCR, and it can be said that the generation quality is improved.

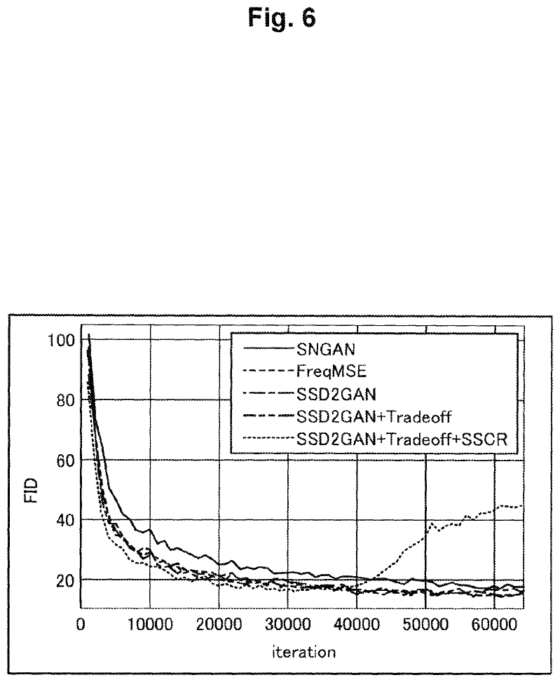

Moreover, over-learning is suppressed by techniques excluding SNGAN as illustrated in FIG. 6. In SNGAN, over-learning occurs after 40,000 iteration, and FID continues to deteriorate.

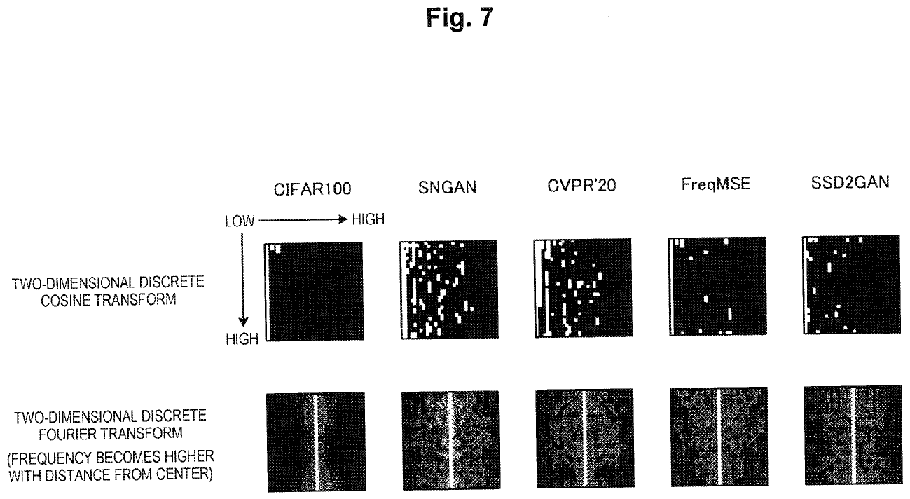

As illustrated in FIG. 7, regarding the conversion function of each frequency component, an effect of suppressing a high frequency component, which does not exist, included in the generated sample appears in FreqMSE and SSD2GAN.

### System Configuration etc.

Moreover, each component of each illustrated device is functionally conceptual, and does not necessarily need to be physically configured as illustrated. That is, a specific form of distribution and integration of devices is not limited to the illustrated form, and all or a part thereof can be functionally or physically distributed or integrated in any unit according to various loads, usage conditions, and the like. Furthermore, all or an arbitrary part of each processing function performed in each device can be implemented by a central processing unit (CPU) and a program analyzed and executed by the CPU, or can be implemented as hardware by wired logic. Note that the program may be executed not only by a CPU but also by another processor such as a CPU.

Moreover, all or some of the processes described as being performed automatically among the processes described in the present embodiment can be performed manually, or all or some of the processes described as being performed manually can be performed automatically by a known method. In addition, the processing procedures, the control procedures, the specific names, and the information including various data and parameters illustrated in the specification and the drawings can be arbitrarily changed unless otherwise specified.

### Program

As an embodiment, the learning device 10 can be implemented by installing a learning program for executing the above learning processing as packaged software or online software in a desired computer. For example, an information processing device can be caused to function as the learning device 10 by causing the information processing device to execute the above learning program. The information processing device mentioned here includes a desktop or notebook personal computer. Moreover, the information processing device also includes a mobile communication terminal such as a smartphone, a mobile phone, and a personal handyphone system (PHS), a slate terminal such as a personal digital assistant (PDA), and the like.

Moreover, the learning device 10 can also be implemented as a learning server device that uses a terminal device used by the user as a client and provides the client with a service related to the learning processing described above. For example, the learning server device is implemented as a server device that provides a learning service having learning data as an input and information of a learned model as an output. In this case, the learning server device may be implemented as a Web server, or may be implemented as a cloud that provides a service related to the learning processing by outsourcing.

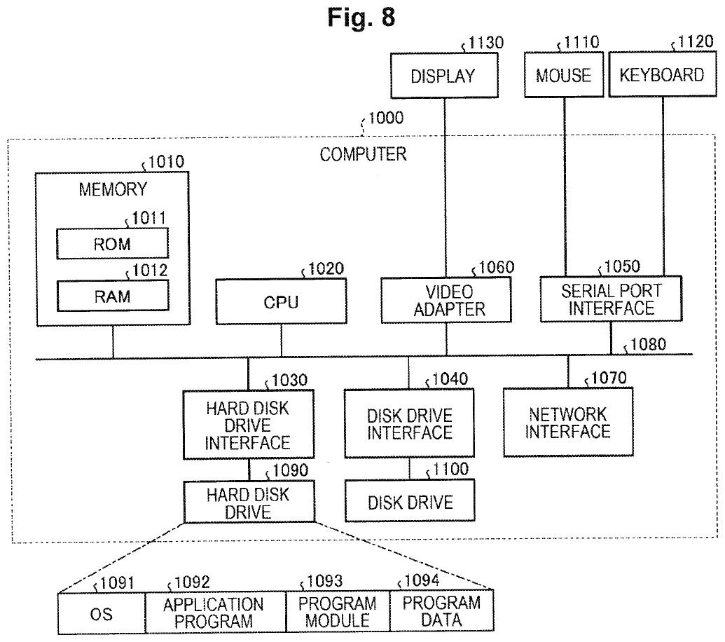

FIG. 8 is a diagram illustrating an example of a computer that executes a learning program. A computer 1000 has, for example, a memory 1010 and a CPU 1020. Moreover, the computer 1000 has a hard disk drive interface 1030, a disk drive interface 1040, a serial port interface 1050, a video adapter 1060, and a network interface 1070. These units are connected with each other by a bus 1080.

The memory 1010 includes a read only memory (ROM) 1011 and a random access memory (RAM) 1012. The ROM 1011 stores, for example, a boot program such as a basic input output system (BIOS). The hard disk drive interface 1030 is connected with a hard disk drive 1090. The disk drive interface 1040 is connected with a disk drive 1100. For example, a removable storage medium such as a magnetic disk or an optical disk is inserted into the disk drive 1100. The serial port interface 1050 is connected with, for example, a mouse 1110 and a keyboard 1120. The video adapter 1060 is connected with, for example, a display 1130.

The hard disk drive 1090 stores, for example, an OS 1091, an application program 1092, a program module 1093, and program data 1094. That is, the program that defines each processing of the learning device 10 is implemented as the program module 1093 in which codes executable by a computer are described. The program module 1093 is stored in, for example, the hard disk drive 1090. For example, the program module 1093 for executing processing similar to the functional configuration in the learning device 10 is stored in the hard disk drive 1090. Note that the hard disk drive 1090 may be replaced with a solid state drive (SSD).

Moreover, the setting data used in the processing of the above-described embodiment is stored in, for example, the memory 1010 or the hard disk drive 1090 as the program data 1094. Then, the CPU 1020 reads the program module 1093 and the program data 1094 stored in the memory 1010 and the hard disk drive 1090 to the RAM 1012 as necessary, and executes the processing of the above-described embodiment.

Note that the program module 1093 and the program data 1094 are not limited to being stored in the hard disk drive 1090, and may be stored in, for example, a removable storage medium and read by the CPU 1020 via the disk drive 1100 or the like. Alternatively, the program module 1093 and the program data 1094 may be stored in another computer connected via a network (local area network (LAN), wide area network (WAN) , etc.). Then, the program module 1093 and the program data 1094 may be read by the CPU 1020 from another computer via the network interface 1070.

### REFERENCE SIGNS LIST

10 Learning device
11 Input/output unit
12 Storage unit
121 Model Information
13 Control unit
131 Generation unit
132 Conversion unit
133 Calculation unit
134 Update unit

1. A learning device, comprising:
conversion circuitry configured to convert first data into a first frequency component and convert second data generated by a generator that configures an adversarial learning model into a second frequency component;
calculation circuitry configured to calculate a loss function that simultaneously optimizes the generator, a first discriminator that configures the adversarial learning model and discriminates between the first data and the second data, and a second discriminator that configures the adversarial learning model and discriminates between the first frequency component and the second frequency component; and
update circuitry configured to update parameters of the generator, the first discriminator, and the second discriminator so that the loss function calculated by the calculation circuitry is optimized.

2. The learning device according to claim 1, wherein:
the calculation circuitry further calculates a loss function having a first term that decreases as discrimination accuracy of the first discriminator increases, and a second term that decreases as discrimination accuracy of the second discriminator increases.

3. The learning device according to claim 2, wherein:
the calculation circuitry calculates a loss function by multiplying the first term by a first coefficient larger than 0 and smaller than 1, and multiplying the second term by a second coefficient obtained by subtracting the first coefficient from 1.

4. The learning device according to claim 1, wherein:
the calculation circuitry further calculates a loss function that decreases as a difference between discrimination accuracy of the first discriminator and discrimination accuracy of the second discriminator decreases.

5. A learning method, comprising:
converting first data into a first frequency component and converting second data generated by a generator that configures an adversarial learning model into a second frequency component;
calculating a loss function that simultaneously optimizes the generator, a first discriminator that configures the adversarial learning model and discriminates between the first data and the second data, and a second discriminator that configures the adversarial learning model and discriminates between the first frequency component and the second frequency component; and
updating parameters of the generator, the first discriminator, and the second discriminator so that the loss function calculated in the calculation step is optimized.

6. A non-transitory computer readable medium storing a learning program for causing a computer to perform the method of claim 5.

7. The learning method according to claim 5, wherein:
the calculating further calculates a loss function having a first term that decreases as discrimination accuracy of the first discriminator increases, and a second term that decreases as discrimination accuracy of the second discriminator increases.

8. The learning method according to claim 7, wherein:
the calculating further calculates a loss function by multiplying the first term by a first coefficient larger than 0 and smaller than 1, and multiplying the second term by a second coefficient obtained by subtracting the first coefficient from 1.

9. The learning method according to claim 5, wherein:
the calculating further calculates a loss function that decreases as a difference between discrimination accuracy of the first discriminator and discrimination accuracy of the second discriminator decreases.
